(19) United States
(12) Patent Application Publication
(10) Pub. No.: US 2026/0202051 A1
(43) Pub. Date: Jul. 16, 2026

(54) Systems and Methods for Picture Frame Backlighting

(71) Applicant: Chris McLaughlin, New Buffalo, MI (US)

(72) Inventor: Chris McLaughlin, New Buffalo, MI (US)

(21) Appl. No.: 19/429,567

(22) Filed: Dec. 22, 2025

Related U.S. Application Data
(60) Provisional application No. 63/738,327, filed on Dec. 23, 2024.

(51) Int. Cl. F21V 33/00; A47G 1/06; F21S 4/20; F21V 7/00; H05B 45/10; H05B 45/20

(52) U.S. Cl. CPC F21V 33/0032; A47G 1/0622; F21S 4/20; F21V 7/0008; H05B 45/10; H05B 45/20

(57) ABSTRACT

A modular picture frame backlighting system for engagement into the interior of a picture frame is provided. The modular backlighting system includes a support frame having a top, bottom, and sides with a LED strip positioned along the interior to emit light into the interior of the backlighting system, and thus onto the rear of a picture canvas when the modular backlighting system is installed in a picture frame. The modular backlighting system also includes a rear reflector and a power/control cable for powering and controlling the LED strip and a diffuser to provide even lighting to the picture canvas.

### CROSS-REFERENCE TO RELATED APPLICATIONS

The present application claims the benefit of U.S. Provisional Application No. 63/738,327, filed December 23, 2024, entitled “Systems And Methods For Picture Frame Backlighting”, which is hereby incorporated by reference in its entirety.

### BACKGROUND OF THE INVENTION

The present invention generally relates to lighting for artworks. More particularly, the present invention relates to a modular picture frame backlighting system that may be installed in a picture frame.

Lighting of an artwork is often an important aesthetic concern of an artist, especially for painted canvas artworks. Painted canvas artworks include a canvas having a first side upon which the artwork has been rendered (which may also be called the artwork side, painted side, or observation side) and a second side opposite the first side, often called the rear of the canvas, back of the canvas, or blank side.

Typical prior art lighting systems for painted canvas artworks include one or more external lights or spotlights that are positioned to emit light that impinges on the artwork side of the painted canvas. Such lights may be positioned at a distance from the painted canvas, such as remote spotlights. In other examples, small lamps may be clamped to the exterior of the picture frame holding the painted canvas artwork.

### BRIEF SUMMARY OF THE INVENTION

One or more of the embodiments of the present invention provide a modular picture frame backlighting system for engagement into the interior of a picture frame in order to provide backlighting to the rear of a canvas held by the picture frame. The modular picture frame backlighting system includes a support frame having first and second lateral sides, a top side, and a bottom side, all having an interior side directed toward the interior of the modular picture frame backlighting system. The interior sides of the top, bottom, and first and second sides include a LED strip with LEDs emitting light into the interior of the modular picture frame backlighting system. Once the modular picture frame backlighting system is installed in a picture frame, the emitted light also impinges upon the rear of the canvas to provide backlighting. A rear reflector is positioned at the rear of the modular picture frame backlighting system to further reflect the emitted light onto the rear of the canvas. The modular picture frame backlighting system is engaged with a picture frame using picture frame engagement structured positioned on the exterior side of the first and second lateral sides. The picture frame engagement structures provide an adhesive or mechanical engagement between the support frame and the picture frame.

### BRIEF DESCRIPTION OF THE DRAWINGS

FIG. 1 is a front plan view into the interior of the modular picture frame backlighting system from the angle that would face the rear of the canvas when installed into a picture frame.

FIG. 2 illustrates the modular picture frame backlighting system installed in a picture frame.

FIG. 3 shows a side view of one side of an embodiment of the modular picture frame backlighting system shown from the interior lateral side of the backlighting system.

FIG. 4 illustrates an alternative embodiment of a picture frame backlighting system according to an embodiment of the present invention.

FIG. 5 illustrates an alternative embodiment of a picture frame backlighting system according to an embodiment of the present invention.

FIG. 6 illustrates a dual-canvas backlighting system according to an embodiment of the present invention.

FIG. 7 illustrates one embodiment of the lighting control unit user interface.

FIG. 8 illustrates an alternative embodiment of the modular picture frame backlighting system having an LED panel.

FIG. 9 illustrates an alternative embodiment of the modular picture frame backlighting system having an LED fabric sheet.

### DETAILED DESCRIPTION OF THE INVENTION

One or more embodiments of the presenting invention provide a modular system for providing backlighting through the rear of a canvas positioned in a picture frame. In one embodiment, a picture appears on the front of the canvas of a picture frame as is typical, but a backlighting system is positioned to the rear of the canvas and provides backlighting to the canvas. This backlighting changes the appearance of the artwork in aesthetically pleasing and interesting ways when observed from the front of the canvas.

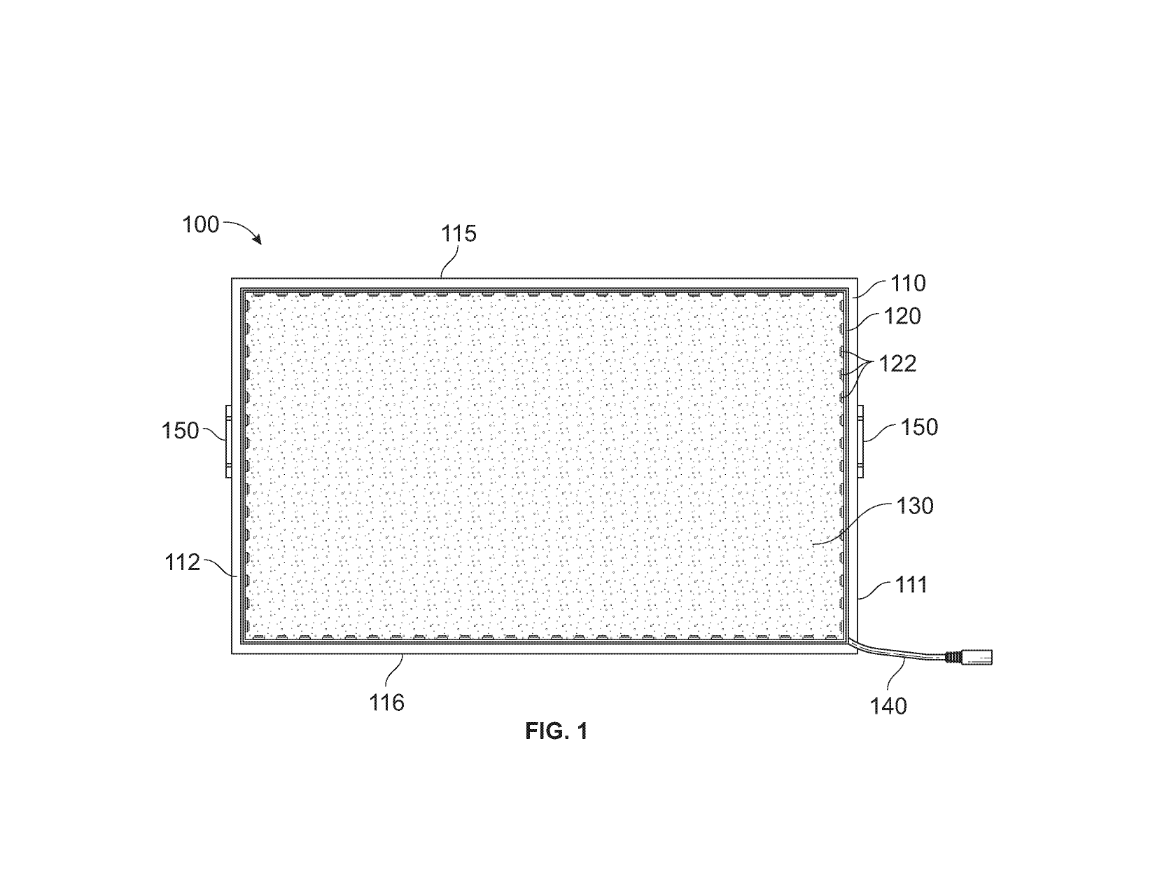

FIGS. 1-3 illustrate a first embodiment of a modular picture frame backlighting system 100 according to an embodiment of the present invention. As further discussed below, the modular picture frame backlighting system 100 represents a unitary structure that is sized to be introduced into a picture frame from the rear of the picture frame and then engage with the interior sides of the picture frame to secure the modular picture frame backlighting system 100 into the picture frame.

FIG. 1 is a front plan view into the interior of the modular picture frame backlighting system 100 from the angle that would face the rear of the canvas when installed into a picture frame. As shown in FIG. 1, the modular picture frame backlighting system 100 includes a support frame 110, a LED (Light Emitting Diode) strip 120 including multiple/many LEDs 122, which is positioned on the inner surface of the support frame 110, a rear reflector 130 stretching across the support frame 110, a power/control cable 140, and picture frame attachment structures 150.

In FIG. 1, the support frame 110 includes a first lateral side 111, a second lateral side 112, a top side 115, and a bottom side 116. As shown, the LED strip 120 is positioned along an interior lateral side of the first lateral side 111, second lateral side 112, top side 115, and bottom side 116. Picture frame attachment structures 150 are positioned on the exterior lateral sides of the first lateral side 111 and the second lateral side 112.

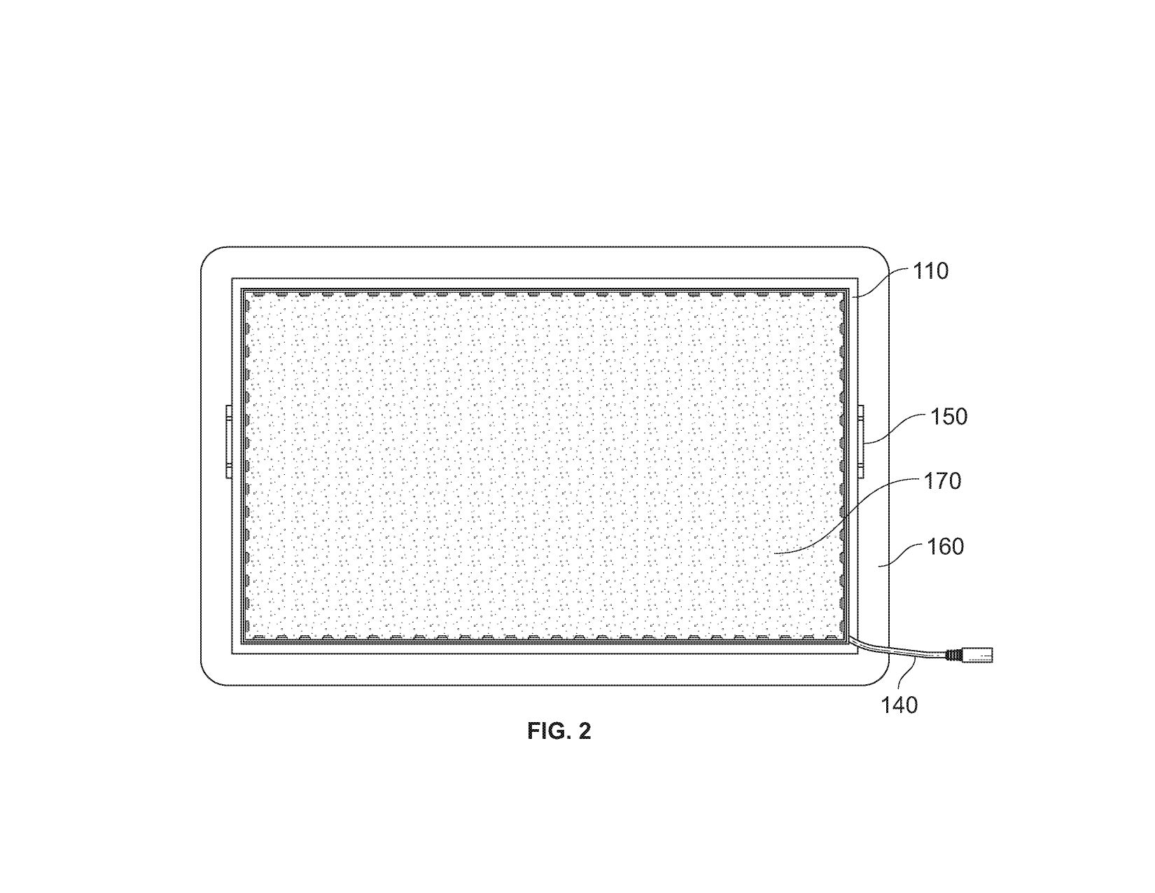

FIG. 2 illustrates the modular picture frame backlighting system 100 installed in a picture frame 160. In the illustration of FIG. 2, the rear reflector 130 that would normally stretch across the support frame 110 at the rear of the support frame 110 has been removed so that the interior of the backlighting system 100 when positioned in the picture frame 160 may be seen. The rear of the canvas 170 at the front of the picture frame 160 also may be seen. Thus, FIG. 2 is illustrating the modular picture frame backlighting system 100 from the opposite angle as shown in FIG. 1. As shown in FIG. 2, the picture frame attachment structures 150 engage with the interior surface of the picture frame as further discussed below to seal, attach, or engage the support frame 100 to the picture frame 160.

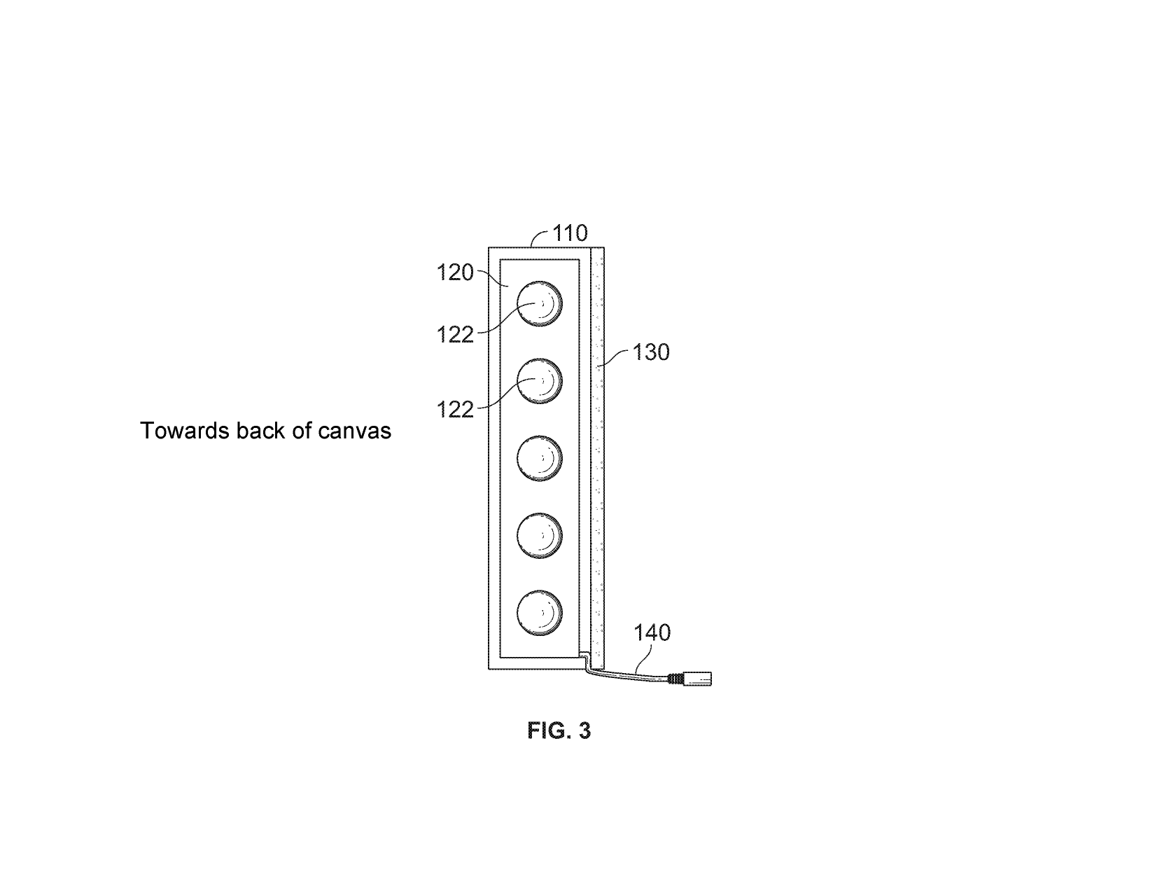

FIG. 3 shows a side view of one side of an embodiment of the modular picture frame backlighting system 100 shown from the interior lateral side of the backlighting system 100. That is, from inside the modular picture frame backlighting system 100 looking outward laterally through the side of the backlighting system 100. The support frame 110, LED strip 120 including many LEDs 122, which is positioned on the inner surface of the support frame 110, the rear reflector 130 stretching across the support frame 110, and the power/control cable 140 are shown.

In operation, as shown in FIGS. 1-3, the modular picture frame backlighting system 100 is positioned into the interior of the picture frame 160 and the picture frame attachment structures 150 engage, seal, or attach the backlighting system 100 with the picture frame 160. The LEDs 122 of the backlighting system 100 may then be powered (illuminated) and controlled by power and/or control signals received from the power/control cable 140. The light emitted by the LEDs 122 is emitted from the sides of the backlighting system 100 into the interior of the backlighting system and then impinges directly on the back of the canvas of the picture frame - and may also impinge on the rear reflector 130 and then be reflected to impinge on the back of the canvas of the picture frame – in order to illuminate the rear of the canvas 170.

With regard to the support frame 110, the size of the support frame may be ¾ of an inch in width, but may alternatively be anywhere in a range of 0.5 to 1.0 inch in width. The support frame may be also be 0.25 inches in thickness, but may alternatively be anywhere in a range of 0.1 to 0.5 inches in thickness. The dimensions of the support frame may be for example (in inches), 16x20, 24x36, 30x40, or 36x48. The support frame may be made of plastic, but may alternatively be made of wood or metal. The picture frame attached to the canvas may be made of the same material as the support frame 110, but may alternatively be composed of a different material such as plastic, wood, or metal.

With regard to the LED strip 120 including many LEDs 122, the LEDs are preferably self-adhesive LED strips such as the self-adhesive LED strips manufactured by GoodEarth Lighting. The separation of the LEDs is preferably about one inch but may be anywhere from one half to two inches. The color temperature of the LEDs is preferably one or more of five different white light colors—2700K soft white, 3000K warm white, 4000K cool white, 5000K daylight, and 6500K deluxe daylight, Prferably, the LED strip provides around 1000 lumens of light. Additionally, in one embodiment, the LEDs are multi-color LEDs that allow their color to be set and/or adjusted using the power/control cable 140.

Because the separation of the LEDs in the LED strip may vary from 0/5 inches to 2.0 inches, and the length of the interior lateral surface of the support frame 110 may vary considerably because the dimensions of the support frame may be for example (in inches), 16x20, 24x36, 30x40, or 36x48, the total number of LEDs in the LED strip may vary considerably. Additionally, the total number of LEDs positioned on each of the interior lateral surfaces of the support frame and/or interior top and bottom surfaces of the support frame may vary. Thus, the number of LEDs shown in FIG. 3 may not be to scale.

In another embodiment, the LED strip may not extend over the entire perimeter of the interior of the support frame. For example, the LED strip may be positioned along one or more of the interior lateral surfaces and/or interior top and bottom surfaces of the support frame.

In one embodiment, the LED strip 120 is adhered to the interior lateral surface of the support frame 110. In alternative embodiments, the LED strip may be attached to the interior lateral surface of the support frame using a mechanical connection such as one or more screws, rivets, or bolts. Alternatively, one or more interior lateral surfaces of the support frame 110 may be constructed so that the LEDs are electrically connected inside the interior lateral surface of the support frame and the interior lateral surface of the support frame includes a plurality of holes through which individual LEDs protrude and emit light into the interior of the support frame 110.

With regard to the rear reflector 130, in one embodiment, the rear reflector includes an adhesive strip that runs around the perimeter of the rear reflector and allows the rear reflector to be attached to the rear surface of the support frame. In one embodiment, the rear reflector may be for example, Reflectix insulation manufactured by Reflectix Inc. Reflectix insulation is light in weight and easy to shape and attach to the support frame. In another embodiment a non-insulated reflector may be employed. Alternatively, the reflector may be attached to the support frame using a mechanical connection such as one or more screws, rivets, or bolts. Additionally, the reflector may be s flexible sheet or a rigid panel.

With regard to the power/control cable 140, in one embodiment, the power/control cable 140 provides power to the LEDs through an electrical connection that passes through the LED strip 120 to each of the LEDs. In another embodiment, the power/control cable 140 may be attached to a control unit that may allow the color temperature of the LEDs to be adjusted either individually or all together. Additionally, the control unit may be used to cause the LEDs to change color over time or adopt other lighting effects such as intermittent blinking, color fades, slow switch, fast switch, multi-color switch, and brightness control. In another embodiment, a control unit may be positioned on the support frame and may be in wireless communication with a remote that may accept lighting adjustment commands from a user.

The power-control cable 140 may provide power from a wall outlet or may alternatively be connected to and provide power from a DC power source such as a battery.

With regard to the picture frame attachment structures 150, in one embodiment, the picture frame attachment structures 150 are a pair of adhesive strips that are positioned on each exterior lateral side of the support frame 110 and are initially protected by a removable protective cover. When a user wants to install the support frame 110 into a picture frame, the user simply removes the protective cover to expose the adhesive strips and then presses the support frame into the picture frame. As mentioned above, the support frame 100 is designed to fit snugly into the picture frame which brings the adhesive strips into contact with the interior surface of the picture frame, where they adhere.

In one embodiment, the adhesive strips may be 1.0mm in thickness and the support frame 110 may be sizes so that it is 2.0mm less wide (to account for both sides of the support frame) than the picture frame 160 into which the modular picture frame backlighting system 100 is to be inserted.

In another embodiment the picture frame attachment structures 150 may be positioned on all four of the exterior lateral sides of the support frame 100 and may engage with or adhere to all four interior sides of the picture frame 160. In one embodiment employing adhesive strips of 1.0mm in thickness, the support frame may be sized so that it is both 2.0mm less wide and 2.0mm less in height than the picture frame 160 into which the modular picture frame backlighting system 100 is to be inserted.

In another embodiment, the picture frame attachment structure may be a rigid structure that mechanically engages with the interior side of the picture fame 160. For example, series of angled spikes or protrusions that extend outwardly from exterior lateral surface of the support frame 110. When the support frame 110 is introduced into the picture frame, the angled protrusion are angled toward the rear of the support frame so that the support frame may be introduced easily into the picture frame, but once introduced, the angle protrusions engage with the interior edge of the picture frame to hold the support frame firmly within the picture frame. Such an embodiment may be especially desirable when the modular picture frame backlighting system 100 is being introduced into a picture frame 160 that is made of wood because the angled spikes will engage firmly into the wood.

Alternatively, a receiving structure may be positioned in the interior side of the picture frame 160 that may engage with the picture frame attachment structure of the support frame 110 in order to secure the support frame 110 to the picture frame 160. In one embodiment, the receiving structure may be composed of one side of a hook-and-loop fastener such as Velcro® and the attachment structure may be composed of the other side of the hook-and-loop fastener. In an alternative embodiment, the receiving structure first may be mechanically attached to the interior of the picture frame and may include mechanical receptacle to receive a mechanical structure of the picture frame attachment structure to secure the support frame 110 to the picture frame 160. In one embodiment, the picture frame attachment structure may include a pin or bar that fits into an aperture or receptacle in the receiving structure. Additionally, the receiving structure may include a mechanical control to allow the picture frame attachment structure to be removed from the receiving structure so that the support frame 110 may be removed from the picture frame 160

In one embodiment, the backlighting system 100 may be applied to the back of the picture frame before the canvas of the picture frame is painted. Alternatively, the backlighting system may be applied to the back of the picture frame after the canvas has been painted.

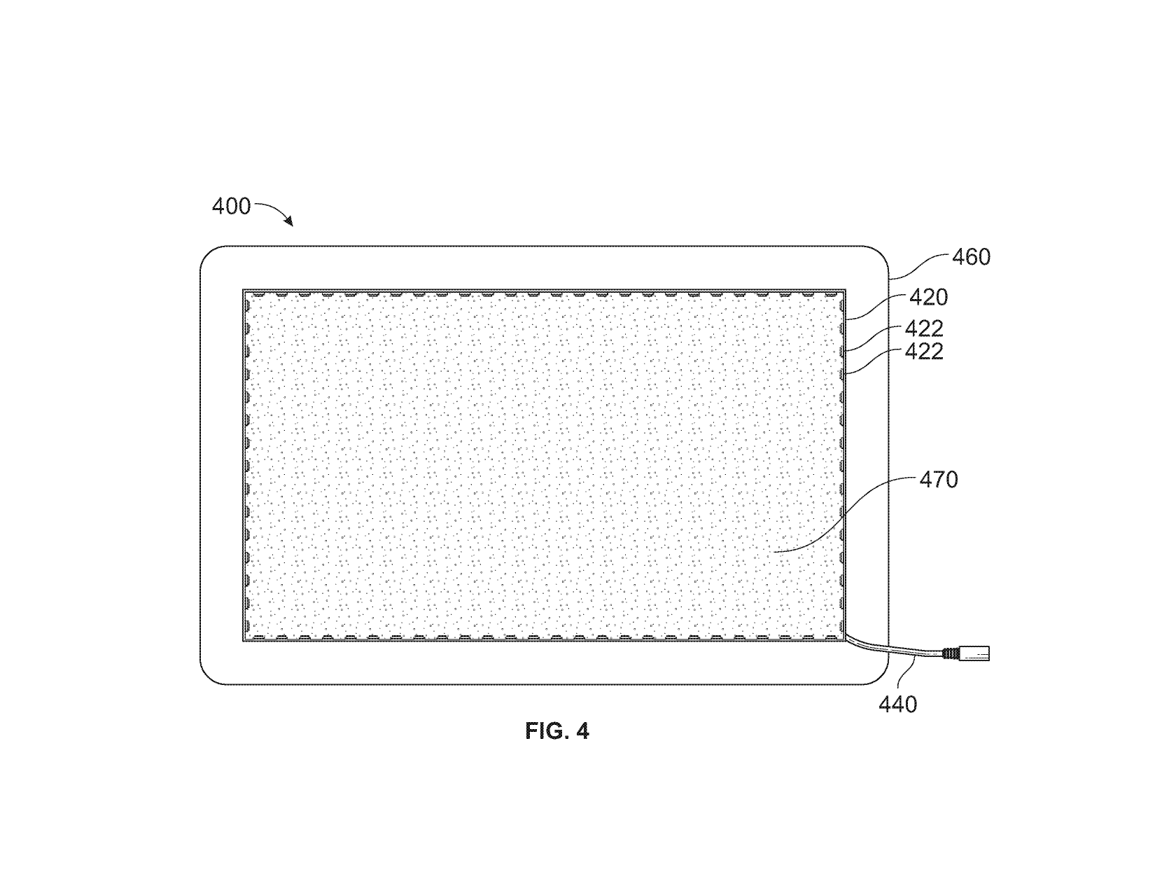

FIG. 4 illustrates an alternative embodiment of a picture frame backlighting system 400 according to an embodiment of the present invention. The embodiment of FIG. 4 differs from the previous embodiments because the backlighting system comes per-installed into the rear frame of the picture frame and the canvas picture frame including the pre-installed backlighting system is sold as a unit.

As shown in FIG. 4, the backlighting system 400 includes a LED strip 420 including many LEDs 422, which is positioned on the inner surface of a picture frame 460, and a power/control cable 440. Additionally, a rear reflector is positioned at the rear of the picture frame 460 covering the picture frame generally as shown above, and is attached to the rear of the picture frame. However, in FIG. 4, the rear reflector has been removed to provide a view into the interior of the pre-installed backlighting system 400.

The elements of FIG. 4 function generally similarly as described above for FIG. 1. However, the attachment structures 150 are not needed because the support frame 110 is already attached to the picture frame 160. In one embodiment, the support frame 110 may be adhered to the picture frame 160 using an adhesive. Alternatively, the support frame 110 may be mechanically connected to the picture frame 160 using a mechanical connector such as bolts, screws, or nuts. In an additional embodiment, the support frame and picture frame 160 are a unitary piece that both holds the canvas 170 and includes the LED strip 120 positioned on its interior lateral side.

Additionally, in the present embodiment of the backlighting system, the canvas of the picture frame may be sold either 1) blank in order to allow an artist to paint their own picture on the picture frame, or 2) already painted with a desired painting or including a pre-rigged printed canvas.

Additionally, in one embodiment, attaching a support frame for the lights to the rear of a painting canvas causes the light to reflect differently and a reflector may not be needed. Because it is attached to the rear of the other canvas the lights are further away from the front of the painted canvas so the light disperses differently and a rear reflector may not be required.

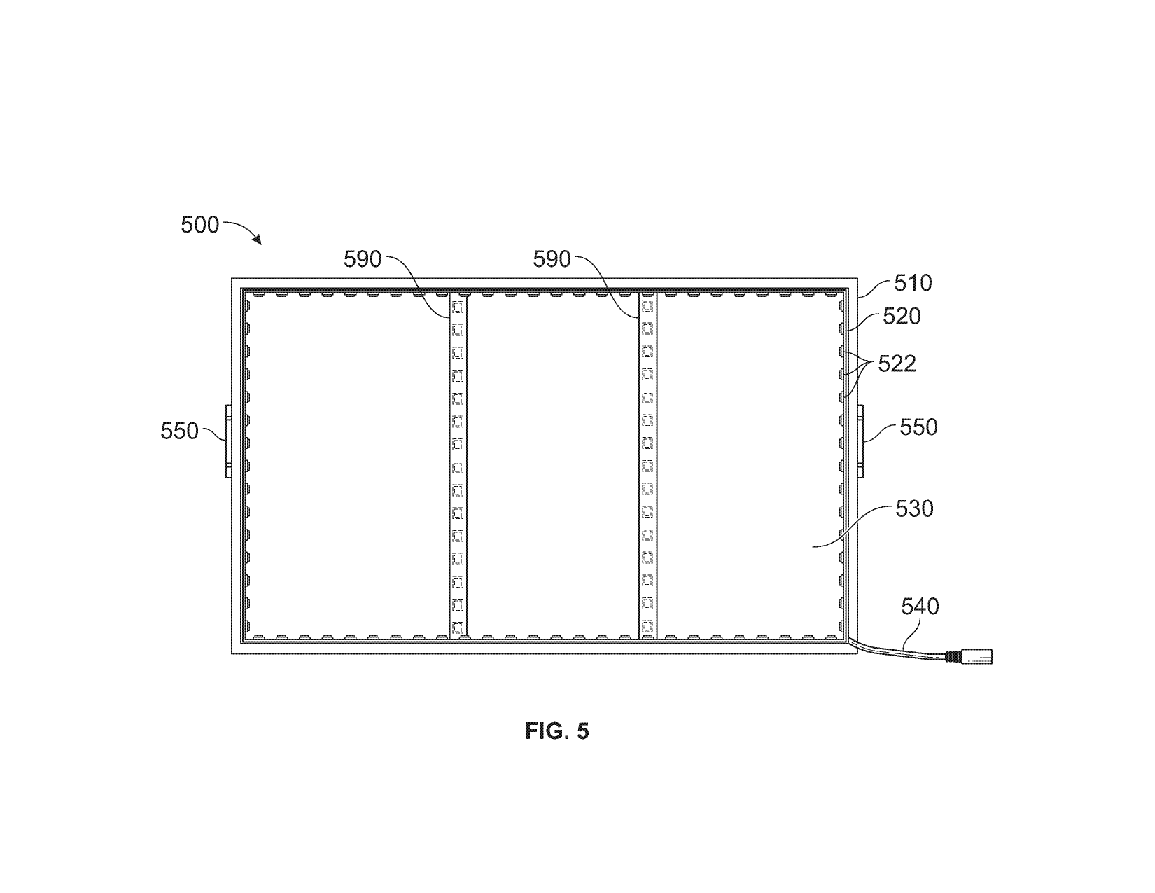

FIG. 5 illustrates an alternative embodiment of a picture frame backlighting system 500 according to an embodiment of the present invention. The backlighting system 500 of FIG. 5 is similar to that of FIG. 1, but includes additional LED strips 590 positioned on the interior surface of the rear reflector 530.

As shown in FIG. 5, the backlighting system 500 includes a support frame 510, a LED strip 520 including many LEDs 522, which is positioned on the inner lateral surface of the support frame 510, a rear reflector 530 stretching across the support frame 510, a power/control cable 540, and picture frame attachment structures 550. Similar to FIG. 1, FIG. 5 is a view into the interior of the backlighting system 500 from the direction that would face the rear of the canvas when installed into a picture frame.

As shown in FIG. 5, two additional LED strips 590 including many/multiple LEDs are positioned on the interior surface of the rear reflector 530 extending from the top cross-member of the support frame to the bottom cross-member of the support frame. The additional LED strips 590 may also be controlled using the power/control cable 540.

In an alternative embodiment, instead of two additional LED strips 590, one strip, three strips, or more may be employed. Additionally, the additional LED strips 590 may extend from one side of the rear reflector 530 completely across the rear reflector to the other side, or may only extend partially across the rear of the rear reflector.

Alternatively, the LED strips may be positioned horizontally between left and right cross-members of the support frame and/or in a diagonal configuration.

In one embodiment, the backlighting system 500 includes a diffuser panel that is positioned between the LEDs positioned on the rear reflector 530 and the back surface of the canvas when the backlighting system 500 is installed into a picture frame. The diffuser panel may be adhered to the interior surface of the support frame 510 (for example using adhesive tape, glue, or mechanical attachments) and may stretch across the support frame 510. The diffuser panel diffuses the lights from the LEDs positioned on the rear reflector 530 to create a more even light distribution.

In one embodiment, the power/control cable 540 may be replaced with a battery pack attached to the interior or exterior of the support frame 510. The battery pack may provide the power to the LEDs and may include replaceable batteries or may be rechargeable, for example using a USB connection. As an additional alternative, a lighting control unit may also be attached to the interior or exterior of the support frame 510 and may include a wireless connection, such as a Bluetooth connection to a remote controller unit. A user may enter lighting commands using the remote controller unit and the lighting commands may then be wirelessly transmitted to the lighting control unit for implementation.

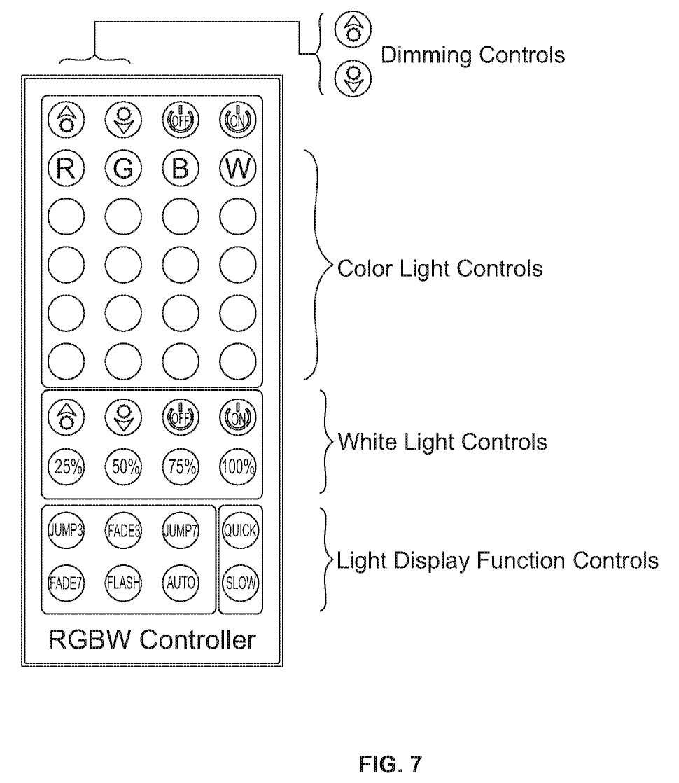

One embodiment of the lighting control unit user interface is shown in FIG. 7. As shown in FIG. 7, the lighting control unit user interface allows the user turn the lighting unit off and on and includes dimming controls to raise and lower the dimming levels of the lighting unit. The lighting control unit user interface also includes color light controls comprising four columns, a red column, a green column, a blue column and a white column. Each column includes multiple color selections that may be selected by the user. The lighting control unit user interface also includes white light controls that control the white lights in the lighting unit. The white lights may be turned off and on and dimming controls to raise and lower the dimming levels of the white lights are included. Additionally, pre-determined dimming levels may also be selected, such as 25%, 50%, 75%, and 100%. The lighting control unit user interface also includes light display function controls which allow each of the red, green, and blue column selections to be set to either appear to jump from one LED to another or to fade by sequentially decreasing and then increasing the amplitude of the light emitted from the LEDs.

In one embodiment, lighting controls may be positioned on the exterior of the support frame 510 so that the LED lighting may be controlled after the support frame 510 is installed into a picture frame.

In one embodiment, support brackets that may be on the back of the support frame are sized to allow a space just underneath the front of the painted canvas for the diffuser panel so that the diffuser panel may be tucked in around the outer frame just underneath the canvas. The diffuser panel then disperses the light from the LED lights. In one embodiment, a small space (approximately 1mm) is established in the support frame in between the rear of the painted canvas and the wood that is the support right underneath the canvas so that the diffuser panel may be inserted in between both sides of the support frame and be supported there.

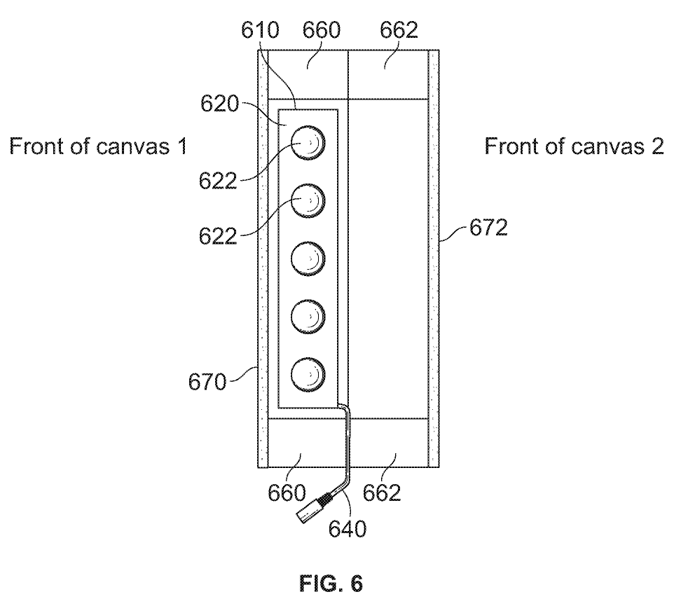

FIG. 6 illustrates a dual-canvas backlighting system 600 according to an embodiment of the present invention. The dual-canvas backlighting system 600 is similar to the systems of FIGS. 1-4 – but positions the backlighting system sandwiched between two canvases – that either include separate images or may be blank canvases that may be painted separately. The rear reflector 130 is removed to that the LED light may impinge on the rear of both canvases at once. Additional LED strips may also be included simply extending between the top and bottom crossbars and/or along the interiors of both of the dual canvases.

FIG. 6 shows a side view of one side of an embodiment of the dual-canvas backlighting system 100 shown from the interior of the backlighting system 100. The support frame 610, LED strip 620 including multiple/many LEDs 622, which is positioned on the inner surface of the support frame 610, and the power/control cable 140 are shown. As shown in FIG. 6, the support frame 610 has been installed in a first picture frame 660 that includes a first canvas 670, similar to the embodiment shown in FIG. 1. Attached to the first picture frame 660 is a second picture frame 662 that includes a second canvas 672. Because there is no rear reflector in the support frame 610, the LEDs 622 illuminate the rear of both the first canvas 670 and the second canvas 672.

Additionally, instead of only one support frame 610 with LED strip 620 being installed in the dual-canvas backlighting system, an additional support frame with an additional LED strip may be installed in the second picture frame. In this embodiment, each support frame has its own power/control cable. Alternatively, a dual-support frame system may include as one unit a left side picture frame structure that includes a first LED strip and engages with the left side picture frame – as well as a right side picture frame structure that includes a second LED strip and engages with the right side picture frame.

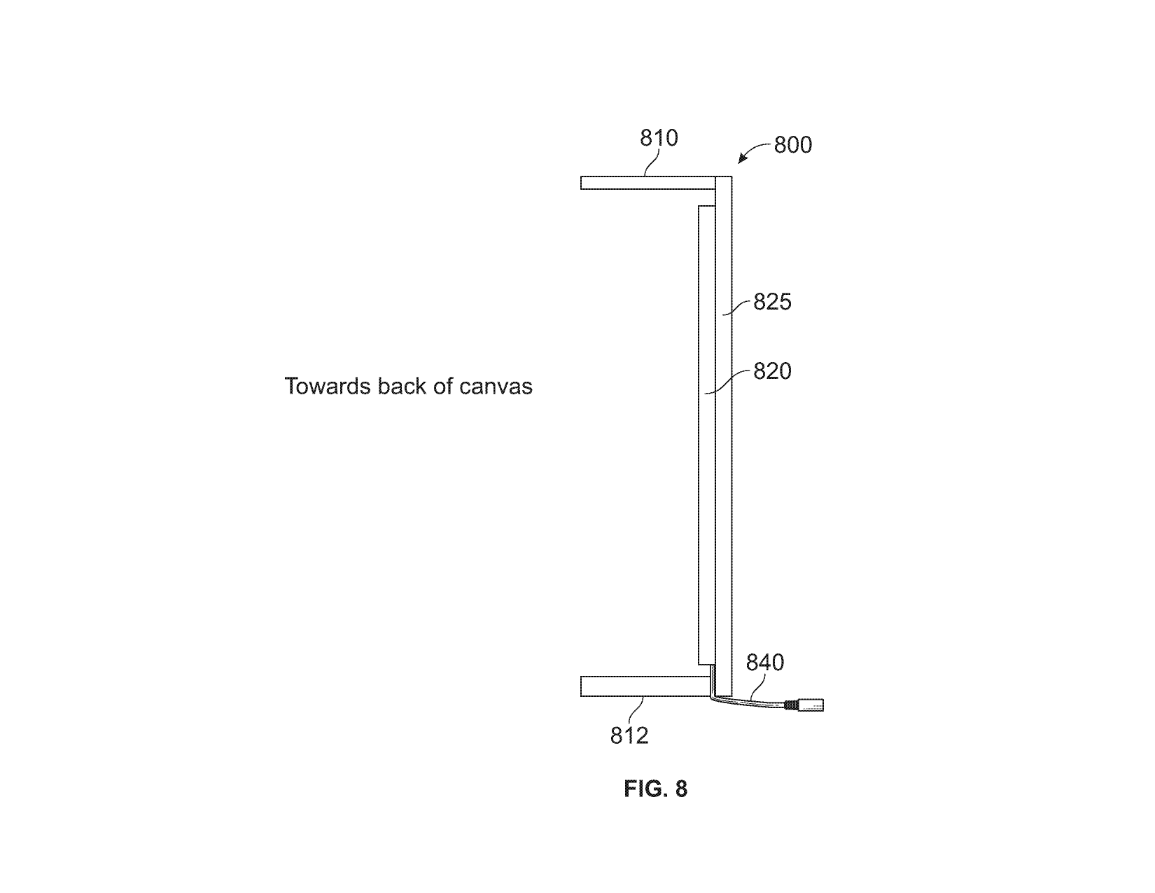

FIG. 8 illustrates an alternative embodiment of the modular picture frame backlighting system 800 having an LED panel. FIG. 8 shows a cut away view through the center of an embodiment of the modular picture frame backlighting system 800. FIG. 8 shows a support frame top side 810, a support frame bottom side 812, a power/control cable 840, a rear cover 825, and an LED panel 820 positioned on the rear cover 825.

In the embodiment of FIG. 8, the LED strip has been replaced with a LED panel 820 positioned on the rear cover 825 at the rear of the support frame. The LED panel 820 receives power and/or control signals from the power/control cable 840 that may cause the LED panel 820 to illuminate the interior of the support frame. The LED panel 820 may be affixed to the rear cover 825 at the rear of the support frame as shown in FIG. 8, or may be positioned in the interior of the support frame between the top and bottom sides of the support frame 810, 812.

In one embodiment, the LED panel may be an LED panel manufactured by WareLight® providing a selectable wattage of one or more of 20/25/30/40/50W, a selectable Correlated Color Temperature of one or more of 30/35/40/50/65K, a selectable light output of 2500/3125/3750/5000/6250Lm, and be dimmable. In one embodiment, the LED panel be adhered to the rear cover 825 or may be attached to the rear cover 825 using a mechanical connection such as rivets, bolts, or screws.

In an alternative embodiment, instead of the LED panel 820 being attached to the rear cover 825, the rear cover 825 may be eliminated and the LED panel attached directly to the interior of the support frame or to the rear edge of the support frame. In one embodiment, the LED panel be adhered to the support frame or may be attached to the support frame using a mechanical connection such as rivets, bolts, or screws.

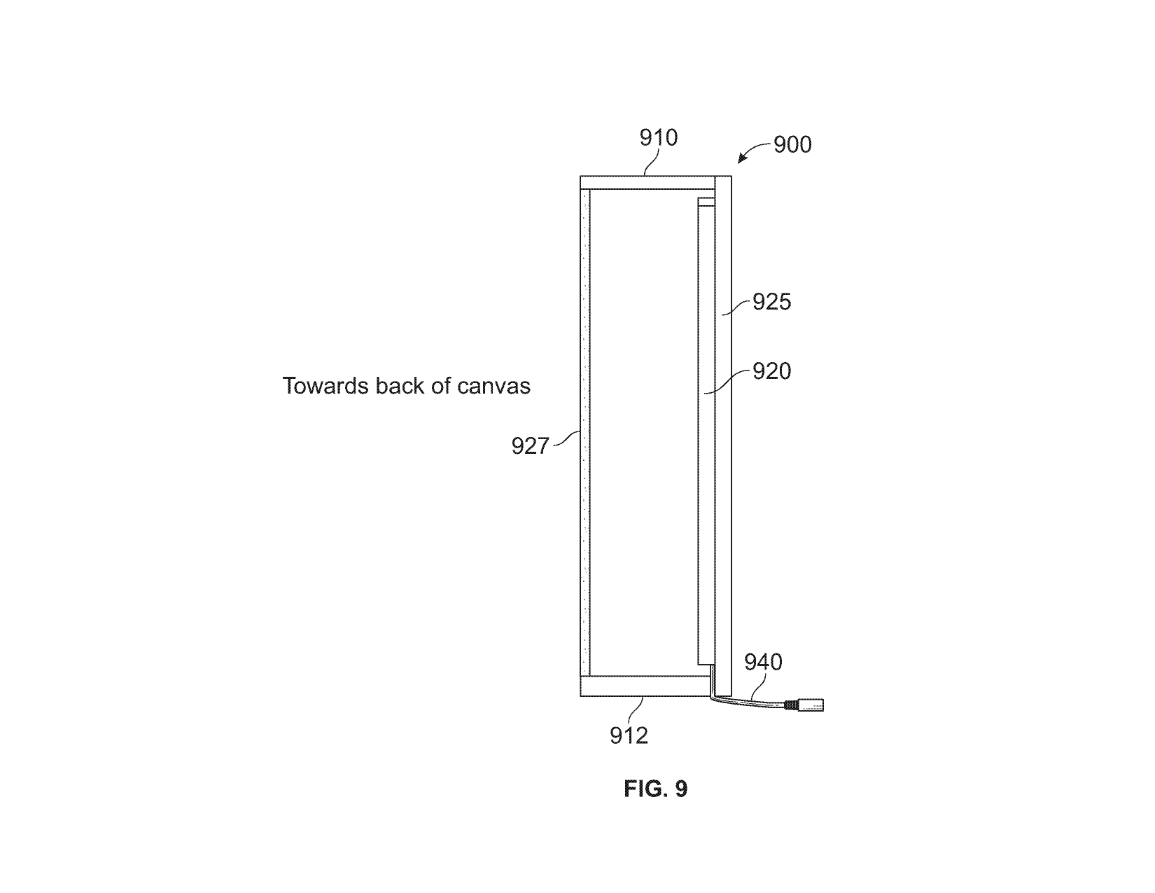

FIG. 9 illustrates an alternative embodiment of the modular picture frame backlighting system 900 having an LED fabric sheet. FIG. 9 shows a cut away view through the center of an embodiment of the modular picture frame backlighting system 900. FIG. 9 shows a support frame top side 910, a support frame bottom side 912, a power/control cable 940, a rear cover 925, an LED fabric sheet 920 positioned on the rear cover 925, and a front diffuser 927.

In the embodiment of FIG. 9, the LED strip has been replaced with a LED fabric sheet 920 positioned on the rear cover 925 at the rear of the support frame. The LED fabric sheet 920 receives power and/or control signals from the power/control cable 940 that may cause the LED fabric sheet 920 to illuminate the interior of the support frame. The LED fabric sheet 920 may be affixed to the rear cover 925 at the rear of the support frame as shown in FIG. 9, or may be positioned in the interior of the support frame between the top and bottom sides of the support frame 910, 912. The diffuser 927 is preferably a translucent panel that serves to diffuse the light provided by the LED fabric sheet 920 so that a more even light distribution is provided to the back of the canvas.

In one embodiment, the LED fabric sheet may the Flexible LED Sheet sold by SuperbrightLEDs.com providing up to 400 LEDs per sheet and a selectable Correlated Color Temperature of one or more of 17/30/35/40/50/65K. In one embodiment, the LED fabric sheet may be composed of segments with individual LEDs that are 2.0in by 1.0in. In one embodiment, the LED fabric sheet be adhered to the rear cover 925 or may be attached to the rear cover 925 using a mechanical connection such as rivets, bolts, or screws.

In one embodiment, the diffuser may be positioned in the interior front of the support frame as shown in FIG. 9. Alternatively, the front edge of the support frame may include a cut-out portion on the front edge of the support frame sized to accept a diffuser panel that has vertical and/or horizontal dimensions greater than the interior of the support frame.

In an alternative embodiment, the embodiments of FIGS. 1-6 may be additionally equipped with a rear cover as shown in FIGS. 8-9 and the reflector 130 may be attached to the rear cover. In one embodiment, the reflector may be adhered to the rear cover or may be attached to the rear cover using a mechanical connection such as rivets, bolts, or screws.

In an alternative embodiment, the embodiments of FIGS. 1-6 may be additionally equipped with a diffuser as shown in FIG. 9.

While particular elements, embodiments, and applications of the present invention have been shown and described, it is understood that the invention is not limited thereto because modifications may be made by those skilled in the art, particularly in light of the foregoing teaching. It is therefore contemplated by the appended claims to cover such modifications and incorporate those features which come within the spirit and scope of the invention.

1. A modular picture frame backlighting system for engagement into the interior of a picture frame, said system including:
a support frame having a first lateral side, a second lateral side, a top side, and a bottom side;
a plurality of LEDs positioned on the interior lateral sides of said first lateral side, said second lateral side, said top side, and said bottom side;
a power cable providing power to said plurality of LEDs;
a rear reflector extending between said first lateral side, said second lateral side, said top side, and said bottom side; and
a plurality of picture frame engagement structures positioned on the exterior lateral sides of said first lateral side and said second lateral side,
wherein said picture frame engagement structures engage the interior sides of a picture frame to engage said modular picture frame backlighting system into said picture frame,
wherein said picture frame holds a picture canvas,
wherein, when power is provided to said LEDs using said power cable, said LEDs emit light that illuminates the rear of said picture canvas.

2. The modular picture frame backlighting system of claim 1 further including a diffuser panel positioned opposite said rear reflector.

3. The modular picture frame backlighting system of claim 2 wherein said diffuser panel is positioned between said interior lateral sides of said first lateral side, said second lateral side, said top side, and said bottom side.

4. The modular picture frame backlighting system of claim 1 further including a rear cover.

5. The modular picture frame backlighting system of claim 4 wherein said rear reflector is positioned on said rear cover.

6. The modular picture frame backlighting system of claim 1 wherein at least one of said plurality of picture frame engagement structures is an adhesive.

7. The modular picture frame backlighting system of claim 1 wherein at least one of said plurality of picture frame engagement structures is a mechanical structure that engages with the interior surface of said picture frame.

8. The modular picture frame backlighting system of claim 7 wherein said picture frame is made of wood and said at least one of said plurality of picture frame engagement structures is a metallic protrusion that engages into the wood of said picture frame.

9. The modular picture frame backlighting system of claim 1 further including a controller transmitting control signals to said LEDs using said power cable.

10. The modular picture frame backlighting system of claim 9 wherein said controller transmits a control signal to dim said LEDs.

11. The modular picture frame backlighting system of claim 9 wherein said LEDs are variable color LEDs and said controller transmits a control signal to change the color of the light emitted by said LEDs.

12. The modular picture frame backlighting system of claim 9 wherein said controller receives control signals from a wireless remote control unit.

13. The modular picture frame backlighting system of claim 1 wherein said power cable receives power from a wall outlet.

14. The modular picture frame backlighting system of claim 1 wherein said power cable receives power from a battery pack.

15. The modular picture frame backlighting system of claim 1 further including at least one additional LED positioned on said rear reflector.
